(19) United States
(12) Patent Application Publication
(10) Pub. No.: US 2002/0044339 A1
(43) Pub. Date: Apr. 18, 2002

(54) Optical transmission system with reduced raman effect depletion

(75) Inventors: Jose Chesnoy, Paris (FR); Jean-Pierre Blondel, Buc (FR); Eric Brandon, Bourg La Reine (FR); Laurent Labrunie, Paris (FR); Denis Toullier, Fleury Les Aubrais (FR)

Correspondence Address: SUGHRUE MION ZINN MACPEAK & SEAS, PLLC, 2100 Pennsylvania Avenue, NW, Washington, DC, 20037-3213, US

(73) Assignee: ALCATEL

(21) Appl. No.: 09/895,267

(22) Filed: Jul. 2, 2001

(30) Foreign Application Priority Data
Jul. 3, 2000 (EP) 00 401 898.2

(51) Int. Cl. H01S 3/00

(52) U.S. Cl. 359/337

(57) ABSTRACT

WDM transmission system comprising transmitters 2 for generating optical signals in different channels, a multiplexer 3 for combining said optical signals into a WDM signals, a transmission line 4 for transmitting said WDM signal, a demultiplexer 6 for demultiplexing the WDM signal received from the transmission line 4 and receivers 7 for receiving the optical signals of each channel, characterized in that it further comprises a Raman depletion compensator 8, 10 for compensating the depletion due to Raman-shift in the power of the wavelength grid spectrum.

The invention relates to a WDM transmission system and to a method for reducing the effect of power depletion in a wavelength grid spectrum due to Raman effect in the WDM transmission system.

Optical wavelength-division multiplex (WDM) transmission systems are known in the prior art. They offer a good optical-fiber bandwidth utilization efficiency as a result of optical wavelength-division multiplexing (WDM). Under these circumstances, a number of modulated optical carriers having different wavelengths are modulated by data information and are transmitted simultaneously through a transmission line including at least an optical fiber. A separate light source, such as a laser, is provided at the transmitting end for each channel. At the transmitting end of the transmission line, a multiplexer is used to combine the signals of eaach channel and, conversely, a demultiplexer is connected at the receiving end to demultiple the WDM signal into the a plurality of signals. Along the transmission line, regenerators might be implemented, whose purpose is to amplify and possibly regenerate the optical signal. In this connection, EDFA (erbium-doped fiber amplifiers), in particular, are used for the amplification. Furthermore, compensation for the dispersion effects that are caused by the transmitting fibers is undertaken in the transmission system. In particular, dispersion-compensating fibers (DCF) may be used.

In WDM transmission systems, Raman effect occurs in optical fibers. This effect can be observed when data signals with high power or high power pump signals are transmitted though the fiber. The Raman effect is a scattering process of a photon at a molecule oscillation. The energy level of the scattered photon is shifted to lower wavelength as a Stoke wavelength. The Raman shift depends only from the material, not from the exciting wavelength. With the coherent Raman effect a very effective amplification of the Stoke wavelengths occurs.

Considering the transmission of the two wavelength channels: The Raman effect induces an energy transfer from the channel with the shorter wavelength to the channel with the longer wavelength. Consequently the power of the first channel decreases and in the same time the power level of the second channel increases. This power reduction for the shorter wavelength signal is called power depletion by Roman effect. The energy transfer is at its maximum for a channel spacing of about 100 nm (in a 1550 nm range) in a silicon fiber.

Following the ITU recommendation G. 692, several channel spacings are allowed for a wavelength division multiplex system. For general spacings of 50 GHz on a fiber the allowed channel frequencies are based on a 50 GHz grid with a reference frequency of 194,1 GHz. For channel spacings of 100 GHz or more on a fiber the allowed channel frequencies are based on a 100 GHz grid with a reference frequency at 193,1 THz. For these transmission systems, the channel spacing is one nanometer or less. The transfer of energy from one channel to the neighbouring channel is far away from the maximum effect of Raman depletion. However when a large number of channels and/or a large signal power is considered, the Raman depletion can be significant enough and can reduce the system performances. The systems performances can be degraded by two effects: a power reduction of the shortest wavelengths of the wavelength grid by Raman depletion and degradation of the longest wavelength channels due to non-linear effects. These non-linear effects, occuring for large channel powers, are self-phase modulation, cross-phase modulation, Brillouin scattering, four-wave mixing and stimulated Raman scattering.

As a result of the Raman scattering, the transmitted wavelength grid spectrum is modified in such way that the power in the channels with the smallest wavelength is shifted to channels with longer wavelengths.

It is known to pre-emphasize the channels in the transmitted means to compensate the inter-channel depletion. This technique consists in an accurate adjustment of the channel power at the transmit side of the transmission line. It is possible to launch the shortest wavelength channels with a larger power than the longest wavelength channels. Over the transmission line the power depletion due to Raman effect occurs and the receiver receives a compensated wavelength grid spectrum with equivalent power levels. This method requires high power levels for the channels with the shortest wavelength. Consequently these channels will be degraded by non-linear effects which will reduce the system performance. The objective of the invention is to avoid the effect of power depletion in the channels and to establish a good performance for all channels of a wavelength grid.

### SUMMARY OF THE INVENTION

The invention consists in a WDM transmission system comprising transmitters for generating optical signals in different channels, a multiplexer for combining said optical signals into a WDM signals, a transmission line for transmitting said WDM signal, a demultiplexer for demultiplexing the WDM signal received from the transmission line and receivers for receiving the optical signals of each channel, said system being characterized in that it further comprises a Raman depletion compensator for compensating the depletion due to Raman-shift in the power of the wavelength grid spectrum.

According to a first embodiment of the invention, the compensation is provided by an additional optical pump signal. This has the advantage that the effect of depletion can actively be modified by Raman pumping. According to another embodiment of the invention, the compensation is provided by adding in-line transmission filters in the transmission system. These filters are passively decreasing the effect of depletion. It is also possible to use both in-line filters ans an additional optical pump signal.

### DRAWINGS

An exemplary embodiment of the invention is shown in the drawing and explained in details in the description below. In the drawing:

FIG. 1 shows a diagrammatic representation of WDM system with Raman pump,

FIG. 2 shows the Raman pumping scheme a and b,

FIG. 3 shows a second embodiment with in-line transmission filters.

### DESCRIPTION

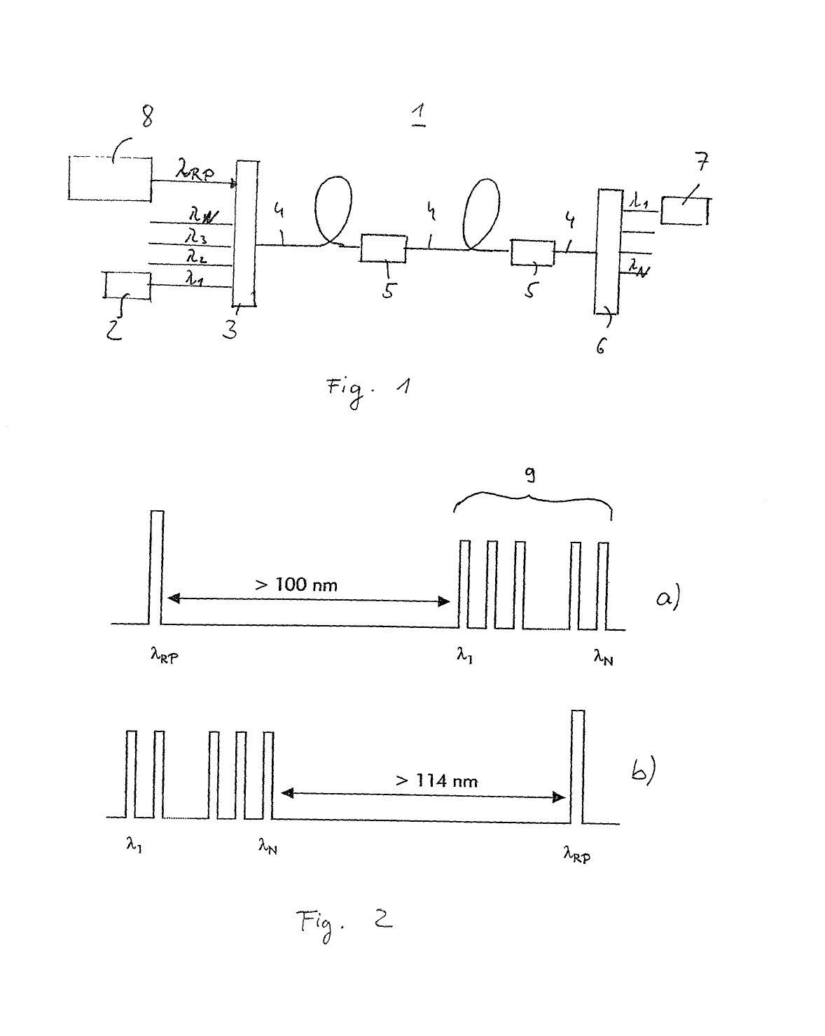

FIG. 1 shows the diagrammatic structure of a DWM transmission system 1. On the transmitting side a number of transmitters 2 transmit optical signals of different wavelengths λ₁ to λₙ. The different optical signals are applied to a multiplexer 3 for generating a WDM signal. The output of the multiplexer 3 is connected with the transmission line 4. The transmission line 4 may contains several regenerators 5. At the receiving side, the WDM signal in the transmission line 4 is applied to a demultiplexer 6. On the outputs of the demultiplexer 6, the optical signals with wavelengths λ₁ to λₙ are applied to receivers 7.

According to a first embodiment of the invention, as shown on FIG. 1, a Raman pump 8 is applied to the input of the multiplexer 3. This Raman pump could also be coupled directly with the transmission line 4, downstream of the multiplexer 3.

It is known from U.S. Pat. No. 5,959,750 to add Raman amplification to an existing transmission system to provide an increase in power budget and to permit substantial increase in transmission capacity. In this system the Raman pump source is provided at the receiving end of the transmission line. Raman pump source in prior art is working at a wavelength of 1453 nm to provide maximum gain over the entire the wavelength range. Such system is not adapted to overcome the problems with Raman depletion in a wavelength grid.

In our invention, the Raman pump source is specially adapted to avoid Raman depletion of the wavelength grid. The Raman pump source is working in propagation direction of the transmission system. To use the Raman laser pump at the transmitting side decreases the problem with non-linearity effects in the transmission line. For the effects of Raman depletion and of Raman shift due to the Raman pumping working parallel the spectrum remains in a very harmonic power scheme.

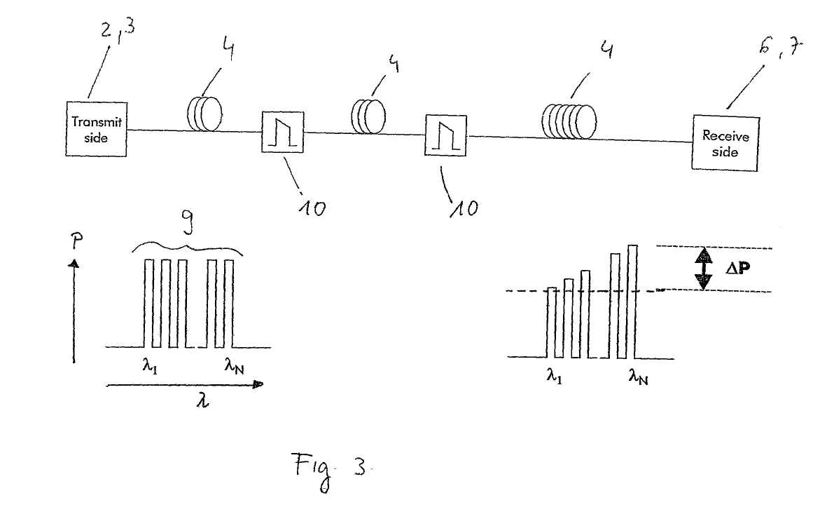

FIG. 2a shows a pumping scheme with a Raman pump having a wavelength shorter than the wavelength grid 9. If the pump wavelength between 80 and 120 nm (preferably, about 100 nm) shorter than the shortest wavelength channel λ₁ of the WDM grid, this channel λ₁ has the greatest benefit of the Raman gain from the Raman pumping. In the same time the longest wavelength channel λₙ will have the lowest Raman gain.

FIG. 2b describes another possible embodiment of the invention. The Raman pump wavelength is larger than the largest wavelength channel λₙ. In that case the power of the channels will be reduced by the pump signal. For example, if the pump wavelength may be between 100 and 130 nm (preferably, about 114 nm) largerthan the largest wavelength channel λₙ, this channel will be more depleted by the pump than the shortest wavelength λ₁. This pump scheme can also be used to compensate the inter-channel depletion. The resulting power of the channel grid is lower than in the first described embodiment. It is advantageous that this pumping scheme reduces the transmission degradation due to non-linear effects for all channels are working at low powers.

The pump source 8 can consist of one laser with one wavelength or for a better adaptation on a wavelength division multiplex system or a plurality of lasers with different wavelengths and different laser powers.

FIG. 3 shows another embodiment of the invention. The transmission system differs from the one of FIG. 1 in that the transmitting side comprises transmitters similar to transmitters 2 and a multiplexer similar to multiplexer 3, but does not include a Raman pump source 8.

According to the invention, Raman depetion effect compensation is provided. On this Figure, this compensation is provided by at least one filter 10 inserted along the transmission line 4.

In the bottom of the Figure, a wavelength grid 9 is shown. This wavelength grid with similar powers in each channel is transmitted from the transmitting side. At the receiving side the resulting wavelength grid is shown. It can be seen that a difference of a Δp occurs between the channels. This difference can be eliminated, or at least reduced, by using the in-line filters 10. One or more filters in the transmission line 4 allow to reduce the transmission degradations due to non-linear impairments.

The filters are selected such that the filter loss increases when the wavelength of the wavelength grid increases. These filters are preferably located near the transmitter end of the transmission system where signal powers are high enough to create Raman depletion. In a transmission system comprising in-line regenerators 5, the in-line filters 10 are preferably located close to the output end of the regenerator 5.

1. WDM transmission system comprising transmitters (2) for generating optical signals in different channels, a multiplexer (3) for combining said optical signals into a WDM signals, a transmission line (4) for transmitting said WDM signal, a demultiplexer (6) for demultiplexing the WDM signal received from the transmission line (4) and receivers (7) for receiving the optical signals of each channel, characterized in that it further comprises a Raman depletion compensator (8, 10) for compensating the depletion due to Raman-shift in the power of the wavelength grid spectrum.

2. Transmission system according to claim 1, characterized in that the Raman depletion compensator comprises an optical pump (8) coupled to the transmission line.

3. Transmission system according to claim 2, characterized in that the optical pump (8) is connected to an input of the multiplexer (3).

4. Transmission system according to claim 2, characterized in that the optical pump (8) is directly coupled to the transmission line (4) through an optical coupler.

5. Transmission system according to claim 3 or 4, characterized in that the wavelength of the optical pump is between 80 and 120 nm shorter that the shortest wavelength of the WDM grid.

6. Transmission system according to claim 3 or 4, characterized in that the wavelength of the optical pump is between 100 and 130 nm larger than the largest wavelength of the WDM grid.

7. Transmission system according to claim 1, characterized in that the Raman depletion compensator comprises at least one in-line filter (10), whose attenuation decreases with increasing wavelengths.
